(19) United States
(12) Patent Application Publication
(10) Pub. No.: US 2012/0103748 A1
(43) Pub. Date: May 3, 2012

(54) SYNCHRONIZATION DEVICE FOR A MANUAL TRANSMISSION

(75) Inventor: Michael Drabek, Brandenburg (DE)

(73) Assignee: ZF FRIEDRICHSHAFEN AG, Friedrichshafen (DE)

(21) Appl. No.: 13/381,734

(22) PCT Filed: Jun. 30, 2010
(86) PCT No.: PCT/EP10/59241

§ 371 Date: Dec. 30, 2011

(30) Foreign Application Priority Data
Jul. 3, 2009 (DE) 10 2009 027 438.3

(51) Int. Cl. F16D 23/02

(52) U.S. Cl. 192/53.3

(57) ABSTRACT

A synchronizer device (100) for a manual transmission which comprises a synchronizer hub (1) and at least one synchronizer ring (2) which can be fixed relative to one another in the circumferential direction by indexing (3). The indexing (3) is formed by at least one projection (4) disposed on the synchronizer ring (2) and which extends substantially in the axial direction and engages in at least one recess (5) of the synchronizer hub (1). The recess (5) on the synchronizer hub (1) comprises at least one oblique surface section (6; 7) on which the projection (4) rests, in a sliding manner, when the synchronizer ring (2) rotates relative to the synchronizer hub (1).

This application is a national stage completion of PCT/EP2010/059241 filed Jun. 30, 2010 which claims priority from German Application Serial No. 10 2009 027 438.3 filed Jul. 3, 2009.

### FIELD OF THE INVENTION

The invention relates to a synchronizer device for a manual transmission comprising a synchronizer hub and at least one synchronizer ring, which can be fixed relative to one another in the circumferential direction by way of indexing, wherein the indexing is formed by at least one projection disposed on the synchronizer ring and extending substantially in the axial direction, which engages in at least one recess of the synchronizer hub. The invention further relates to a synchronizer ring and a synchronizer hub for such a synchronizer device, and a manual transmission comprising such a synchronizer device.

### BACKGROUND OF THE INVENTION

In manual transmissions, when a gear is selected, two parts rotating at different speeds must be coupled using an axially displaceable, third part. Both of the two rotating transmission parts comprise outer gearing which engages in an inner gearing of the third part. The third part is typically in the form of a synchronizer sleeve which is typically connected to a driver-side shift lever by way of a coupling means, and is displaced in the axial direction upon actuation of the shift lever, thereby interconnecting the two engaging parts in a form-locking manner at the end of the shift procedure. If the axially displaceable part, which is engaged with one of the two parts by way of the gearings thereof at the beginning of the shift procedure, would impact the other part which is rotating at a different speed, the impinging gearings would grind, thereby producing unwanted noise and possibly damaging the gearings. This is typically prevented by the use of a synchronizer device. The synchronizer device first brings the two parts to be coupled together to a substantially identical speed of rotation. Only then is the displaceable part displaced axially and the form-locking coupling of the two parts achieved by way of the third part.

Synchronization typically takes place with the aid of at least one synchronizer ring disposed between the two parts to be coupled, namely the gearwheel or idler gear and the synchronizer hub. The synchronizer ring has a rotary drive connection with the synchronizer hub and forms a friction coupling with the gearwheel. Synchronization takes place in that the axially displaceable part, namely the synchronizer sleeve, presses the synchronizer ring via the friction surface thereof against the corresponding friction surface of the gearwheel, thereby engaging the common friction coupling. The synchronizer ring rests against the synchronizer hub in the locking position, i.e. the synchronizer ring and the synchronizer hub are interconnected in a form-locking manner. To this end, the synchronizer ring comprises at least one projection extending substantially in the axial direction, which engages in a corresponding seat opening of the synchronizer hub. This form-locking connection is typically also referred to as indexing. Once the synchronizer hub and the synchronizer ring are brought into the locking position relative to one another, the friction connection between the synchronizer ring and the gearwheel is achieved. Such a generic synchronizer device is known from DE 10 2006 060 535 A1.

It has been shown that the time that is available during a shifting procedure for attaining the coefficient of friction between the friction surfaces of the synchronizer ring and the gearwheel is often insufficient. In such cases, synchronization is not yet achieved when the synchronizer sleeve becomes coupled to the gearwheel, wherein unwanted noise is produced and the gearings of the synchronizer sleeve and the gearwheel may become damaged.

### SUMMARY OF THE INVENTION

The problem addressed by the invention is therefore that of providing a synchronizer device having the initially mentioned features, in which, by way of structural features, more time is provided during the synchronization procedure with the synchronizer ring to attain friction torque relative to the frictional surface of the coupling element or the gearwheel.

The synchronizer device according to the invention is suited for use in a manual transmission such as the manual transmission of a motor vehicle. The synchronizer device comprises a synchronizer hub and at least one synchronizer ring, which can be fixed relative to one another in the circumferential direction by way of indexing. The indexing is formed by at least one projection disposed on the synchronizer ring and extending substantially in the axial direction, which engages in at least one recess of the synchronizer hub. Preferably, the synchronizer ring comprises at least three such projections, and at least three corresponding recesses or seats for the projections are provided on the synchronizer hub.

According to the invention, the at least one recess on the synchronizer hub comprises at least one oblique surface section on which the projection rests in a sliding manner when the synchronizer ring rotates relative to the synchronizer hub.

By way of this structural feature, more time is given to the synchronizer ring during a shift procedure to attain friction torque relative to the friction surface of the coupling element forming a friction coupling with the synchronizer ring, in that a certain rotation of the synchronizer ring relative to the synchronizer hub is permitted during a synchronization procedure.

By way of the oblique surface section of the recess of the synchronizer hub, the projection of the synchronizer ring slides radially outward along the oblique surface section. By way of the measure according to the invention is it therefore achieved that the synchronizer ring, which is disposed relatively loosely in the gear set, can be coupled tightly to the synchronizer hub without forced guidance, thereby preventing rattling or similar noise from being produced if synchronization does not take place.

Furthermore, by way of the projection sliding on the oblique surface section of the recess, a relatively minor breakaway torque is required to separate the friction surface of the synchronizer ring from the friction cone. The release torque is also reduced, i.e. the synchronizer ring can be brought into the so-called “neutral” position thereof relative to the synchronizer hub with less resistance than before.

According to a first embodiment of the invention, the synchronizer hub comprises at least one stop which the synchronizer ring can impact upon rotation relative to the synchronizer hub. As a result, the synchronizer ring can be fixed on the synchronizer hub in the circumferential direction by way of a form-locking connection in that the synchronizer ring impacts the synchronizer hub during rotation thereof.

It is possible for the stop to be formed by at least one wall section of the seat of the synchronizer hub with which a wall section of the projection of the synchronizer ring can impact. As a result, the stop can be achieved in a particularly simple manner since it is possible to utilize the wall sections of the seat on the synchronizer hub and the counter-surface sections of the projection of the synchronizer ring, which are already present anyway.

It is further possible for the stop and the oblique surface section of the synchronizer hub to be disposed one behind the other as viewed in the circumferential direction. As a result, it is made possible in a structurally simple manner for the projection to slide along the at least one oblique surface section and then impact the stop, thereby enabling a form-locking rotational connection to be produced between the synchronizer ring and the synchronizer hub.

Furthermore, the surface section of the recess can be advantageously disposed in an oblique manner such that self-locking between the surface section and the projection of the synchronizer ring can be prevented during operation of the synchronizer device. It is thereby ensured that the synchronizer ring returns to the “neutral” position after reduction of the torsional moment, in particular in that the projection engaging in the recess slides back into the “neutral” position as viewed in the circumferential direction.

Alternatively thereto, the surface section of the recess can also be obliquely disposed such that, upon application of torsional moment, the projection of the synchronizer ring rests against the surface section with self-locking and, upon elimination or reduction of the torsional moment, returns to the neutral position thereof. As a result, the indexing or fixing of the synchronizer ring relative to the synchronizer hub can be accomplished by the force-locking, in particular friction-locking, connection achieved in this manner. It is thereby possible to prevent component-stressing impacts which occur, for example, in the presence of a form-locking connection and a relatively great rotational speed difference between the two transmission parts to be coupled.

According to a further embodiment of the invention, the projection of the synchronizer ring comprises at least one surface section which corresponds, at least partially, to the oblique surface section of the synchronizer hub. The synchronization procedure is supported and simplified by the geometrically corresponding surface on the projection of the synchronizer ring. It is also possible for the projection to thereby slide on the oblique surface of the recess in a manner that is particularly gentle on components and is low-wear.

The corresponding oblique surface section of the projection can be produced by way of a bevel in a manner that is easy to manufacture.

According to a preferred embodiment of the invention, two oblique surface sections are provided for each seat opening on the synchronizer hub, of which the one surface section interacts with the projection of the synchronizer ring upon rotation of the synchronizer ring relative to the synchronizer hub in one direction of rotation, and the other surface section interacts with the projection of the synchronizer ring upon rotation of the synchronizer ring in the other direction of rotation. Preferably, the projection of the synchronizer ring slides along the one oblique surface or the other oblique surface radially outwardly, depending on the direction of rotation thereof.

It is possible for the oblique surfaces of the seat opening on the synchronizer hub to face one another by way of the radially inwardly located ends thereof, preferably being spaced apart from one another. It is furthermore possible for the projection of the synchronizer ring and the oblique surface sections to overlap in the circumferential direction in the “neutral” position of the synchronizer ring. As a result, the rotational degree of freedom of the projection in the seat can be adjusted in a flexible manner and independently of the relative direction of rotation of the synchronizer ring with respect to the synchronizer hub. The projection of the synchronizer ring is therefore held particularly securely in the seat of the synchronizer hub, thereby ensuring that the projection can slide securely in the seat of the synchronizer hub.

The synchronizer device according to the invention can be used for single synchronization or multiple synchronization, preferably double or triple synchronization, which is described by reference to example embodiments. Within the scope of the invention, single synchronization means that the friction coupling of the synchronizer device is achieved by way of one friction pairing. In multiple synchronization, multiple friction pairings are provided accordingly, such as two friction pairings in double synchronization or three friction pairings in triple synchronization, for example.

The synchronizer device according to the invention is used preferably in a manual transmission, in particular a manual transmission for a motor vehicle. A synchronizer hub and a synchronizer ring according to the aforementioned features are claimed separately.

### BRIEF DESCRIPTION OF THE DRAWINGS

The invention is explained in greater detail in the following using an example embodiment, with reference to the attached drawing. It shows

FIG. 1 an embodiment of a synchronizer device for a manual transmission in a sectional view in the region of the indexing of the synchronizer device,

FIG. 2 a section of a synchronizer hub of the synchronizer device according to

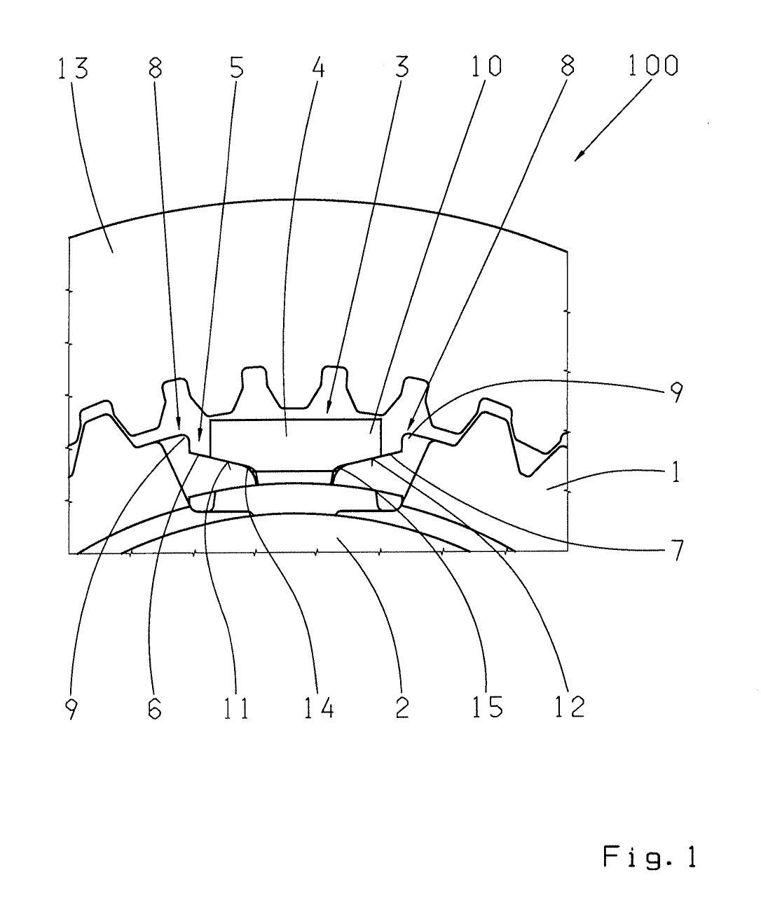

FIG. 1, in a perspective depiction,

FIG. 3 a section of a synchronizer ring of the synchronizer device according to

FIG. 1, in a perspective depiction,

FIG. 4 a synchronizer device having single synchronization, in a sectional view, and

FIG. 5 a synchronizer device having triple synchronization, in a sectional view.

### DETAILED DESCRIPTION OF THE DRAWINGS

FIG. 1 shows, in a schematic representation, a synchronizer device 100 which can be used in a manual transmission of a motor vehicle, for example. The synchronizer device 100 comprises a synchronizer hub 1 and at least one synchronizer ring 2 having locking gearing 17, which can be fixed relative to one another in the circumferential direction by way of geometric indexing 3. The indexing 3 is formed by at least one projection 4 disposed on the synchronizer ring 2 and extending substantially in the axial direction, which engages in a recess 5 or seat of the synchronizer hub 1. The at least one projection 4 is connected as one piece to the synchronizer ring 2 in a manner known per se.

The synchronizer device 100 furthermore comprises a synchronizer sleeve 13 which is coupled to the actuating element of an actuator or to the driver-side shift lever as described initially. When a gear is shifted, the synchronizer sleeve is displaced in the axial direction of the transmission shaft (not depicted), and coupling with the gearwheel (not depicted) of the manual transmission is achieved. In FIG. 1, the synchronizer sleeve 13 is shown in a position in which it is engaged with the outer gearing of the synchronizer hub 1.

The axial recess 5 of the synchronizer hub 1 comprises an oblique surface section 6 on which the projection 4 of the synchronizer ring 2 rests and slides through a specified angle of rotation upon rotation of the synchronizer ring 2 relative to the synchronizer hub 1. On the opposite side of the projection 4 relative to the circumference, the recess 5 comprises a further oblique surface section 7 on which the projection 4 rests and slides through a specified angle of rotation upon rotation of the synchronizer ring 2 relative to the synchronizer hub 1. The oblique surface sections 6, 7 are formed and disposed such that the one surface section 6 interacts with the projection 4 upon rotation of the synchronizer ring 2 relative to the synchronizer hub 1 in one direction of rotation, and the other surface section 7 interacts with the projection 4 upon rotation of the synchronizer ring 2 in the other direction of rotation.

As shown in FIG. 3, and in FIG. 1 in particular, the projection 4 of the synchronizer ring 2 comprises, on the radially inward directed underside thereof facing the oblique surface sections 6, 7 of the recess 5, two oblique surface sections or bevels 11, 12 which correspond to the surface sections 6, 7, respectively, of the recess 5. The mutually corresponding surface sections 6, 11 and 7, 12 are situated at an angle with respect to an imagined surface impinging tangentially on the synchronizer hub 1 such that self-locking between the surface sections 6, 11 and 7, 12, which slide on one another, is prevented in the particular direction of rotation of the synchronizer ring 2 relative to the synchronizer hub 1.

The synchronizer hub 1 comprises at least one stop 8 which the projection 4 of the synchronizer ring 2 can impact upon rotation relative to the synchronizer hub 1. The stop 8 is formed by at least one wall section 9 of the recess 5 of the synchronizer hub 1 with which a counter-surface section 10 of the projection 4 can impact. In the embodiment according to FIG. 1, two stops 8 are provided, which are formed by the particular side walls 9 of the recess 5 of the synchronizer hub 1. Depending on the direction of rotation of the synchronizer ring 2 relative to the synchronizer hub 1, the projection 4 impacts the stop 8 by way of the side 10 thereof facing the side wall 9 of the recess 5 when a certain angle of rotation is exceeded.

The synchronizer hub 1 preferably comprises three seats 5 or grooves distributed evenly about the circumference, in which the projections 4 of the synchronizer ring 2 are supported. The recesses 5 are designed such that the projections 4 of the synchronizer ring 2, which are also referred to as index tabs, must slide across the oblique surface section 6 or 7 to reach the locking position. The locking position is reached when the projection 4 impacts the stop 8 at the end of the oblique surface section 6 or 7.

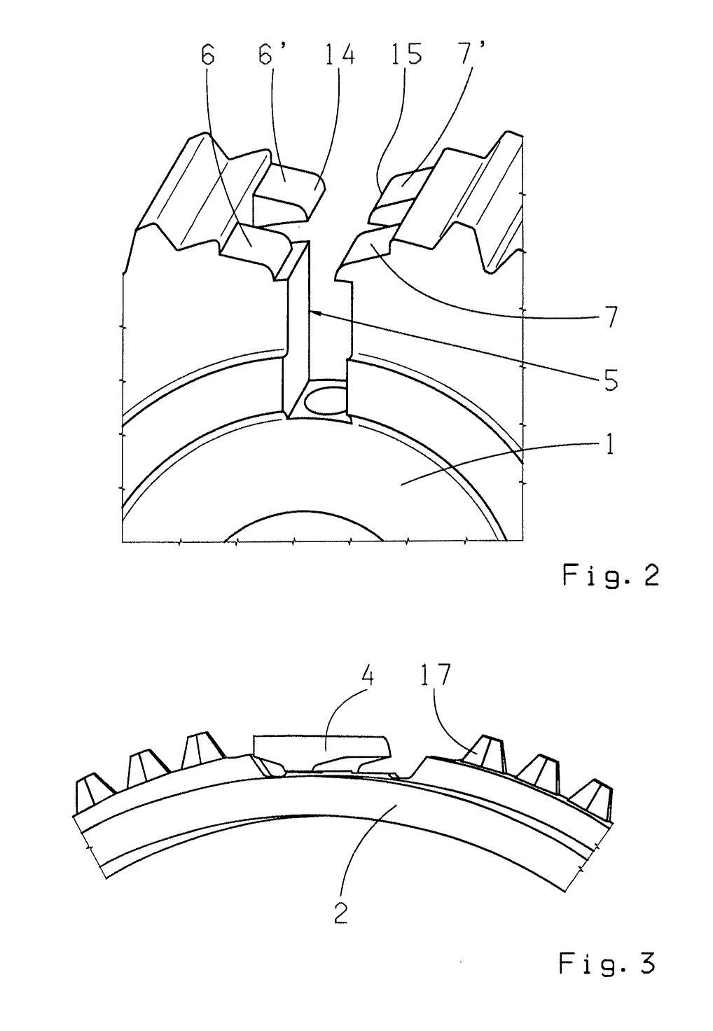

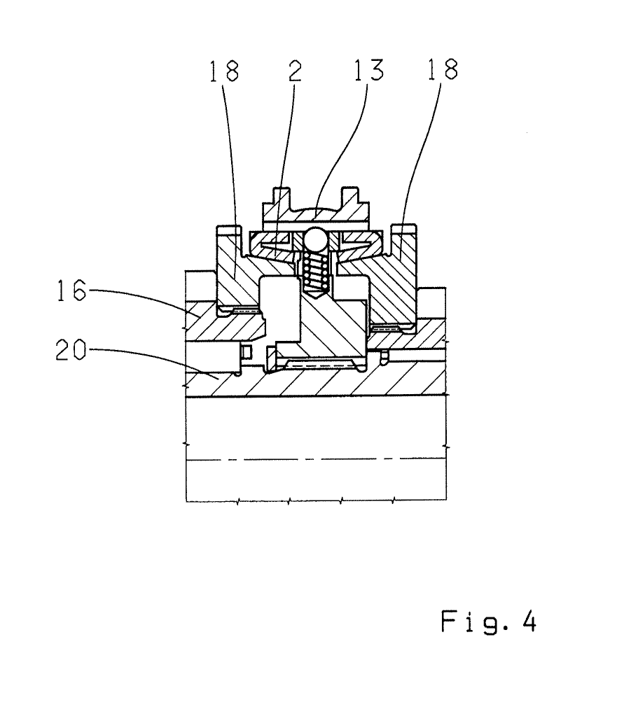

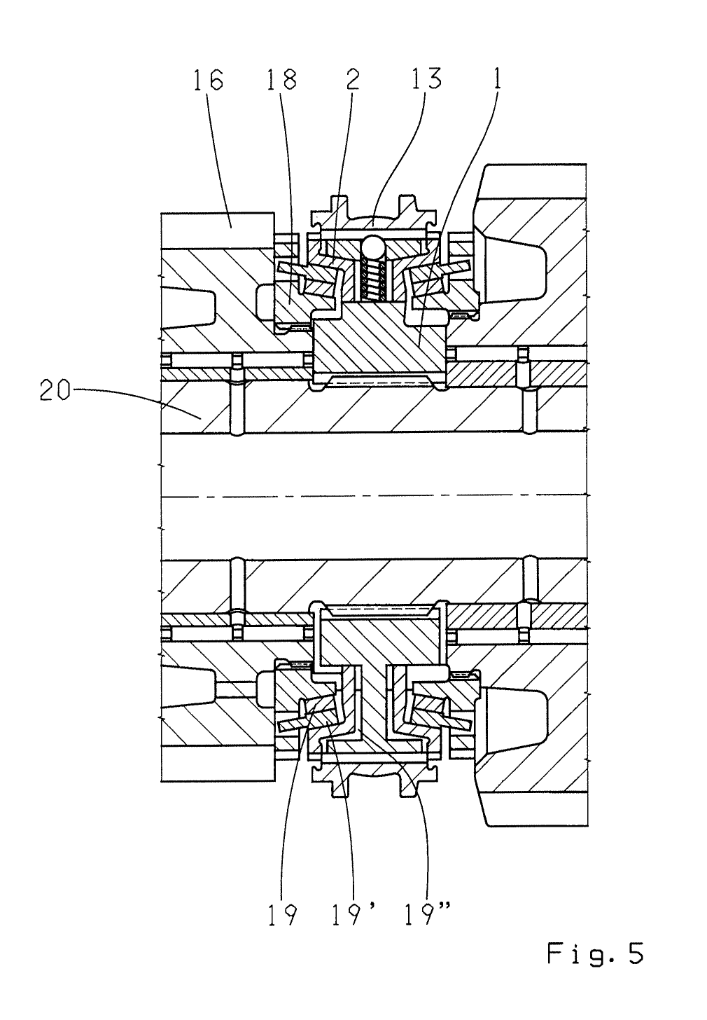

As shown in FIG. 2 in particular, the oblique surface sections 6, 7 face one another by way of the radially inward located ends 14, 15 thereof, the ends 14, 15 being separated from one another. The distance between the oblique surface sections 6, 7 is selected such that the projection 4 and the oblique surface sections 6, 7 overlap in the circumferential direction of the synchronizer hub 1 in the “neutral” position of the synchronizer ring 2.

FIG. 2 furthermore shows that the synchronizer hub 1 preferably comprises two oblique surface sections 6, 6′ and 7, 7′ adjacently disposed in the axial direction, on which the particular projection 4 of the synchronizer ring 2 slides upon rotation of the synchronizer ring 2 relative to the synchronizer hub 1.

The synchronizer device 100 can be in the form of single synchronization or multiple synchronization. FIG. 4 shows the synchronizer device 100 disposed on a transmission shaft 20, wherein the synchronizer device 100 is in the form of single synchronization in this example embodiment. A single synchronizer ring 2 is provided for this purpose, the conical friction surface of which interacts, under the influence of the synchronizer sleeve 13, with the corresponding conical friction surface of the coupling element 18 of the adjacent gearwheel 16.

FIG. 5 shows a further embodiment of the synchronizer device 100 which is in the form of triple synchronization. Three operatively interconnected friction pairings 19, 19′, 19″ are provided for achieving the friction coupling between the gearwheel 16 and the synchronizer hub 1.

By way of the synchronizer device 100 according to the invention, the manual transmission can be designed such that the locking gearing 17 of the synchronizer ring 2 can be optimally designed to meet specified shifting comfort requirements since only a slight breakaway torque is required to separate the friction surfaces 6, 11; 7, 12 which are in contact with one another. The remainder of the release procedure is carried out by the synchronizer ring 2 by way of the spring action of the projection 4 at the oblique surface section 6, 7 itself. Since a large transition angle is not necessary for this case, the particular projection 4 of the synchronizer ring 2 in the “neutral” position can be guided so close to the oblique surface sections 6, 7 of the recess 5 of the synchronization body 1 that the rotational degree of freedom is limited to the extent that the synchronizer ring 2 is prevented from impacting the synchronizer hub 1 merely by accounting for rotational irregularities. The synchronizer device according to the invention serves to improve the pre-synchronization of a manual transmission and prevents rattling from occurring during the synchronization procedure.

### REFERENCE CHARACTERS

1 synchronizer hub
2 synchronizer ring
3 indexing
4 projection
5 recess, seat
6, 6′ surface section of the recess
7, 7′ surface section of the recess
8 stop
9 wall section of the recess
10 wall section of the projection
11 surface section of the projection
12 surface section of the projection
13 synchronizer sleeve
14 end
15 end
16 gearwheel
17 locking gearing of the synchronizer ring
18 coupling element
19 friction pairing
19′ friction pairing
19″ friction pairing
20 transmission shaft
100 synchronizer device

1-16. (canceled)

17. A synchronizer device (100) for a manual transmission, the synchronizer device (100) comprising:
a synchronizer hub (1), and
at least one synchronizer ring (2),
which are connectable with each other in a circumferential direction by an indexing element (3), the indexing element (3) being formed of at least one projection (4) disposed on the synchronizer ring (2) and extending substantially in an axial direction, which engages in at least one recess (5) of the synchronizer hub (1),
the recess (5) having at least one oblique surface section (6; 7) on which the projection (4) rests, in a sliding manner, when the synchronizer ring (2) rotates relative to the synchronizer hub (1).

18. The synchronizer device according to claim 17, wherein the synchronizer hub (1) comprises a stop (8) against which the synchronizer ring (2) impacts upon rotation relative to the synchronizer hub (1).

19. The synchronizer device according to claim 18, wherein the stop (8) is formed by at least one wall section (9) of the recess (5) of the synchronizer hub (1), against which a wall section (10) of the projection (4) can abut.

20. The synchronizer device according to claim 18, wherein the stop (8) and the oblique surface section (6; 7) are disposed one behind the other when viewed in the circumferential direction.

21. The synchronizer device according to claim 17, wherein the oblique surface section (6; 7) is obliquely disposed such that self-locking, between the oblique surface section (6; 7) and the projection (4), is prevented during operation of the synchronizer device (100).

22. The synchronizer device according to claim 17, wherein the oblique surface section (6; 7) of the recess (5) is obliquely disposed such that, upon application of a torsional moment, the projection (4) of the synchronizer ring (2) rests against the oblique surface section (6; 7) with self-locking and, upon either elimination or reduction of the torsional moment, returns back to a neutral position thereof.

23. The synchronizer device according to claim 17, wherein the projection (4) of the synchronizer ring (2) comprises at least one surface section (11; 12) which corresponds, at least partially, to the oblique surface section (6; 7) of the synchronizer hub (1).

24. The synchronizer device according to claim 23, wherein the oblique surface section of the projection (4) is formed by a bevel (11; 12).

25. The synchronizer device according to claim 17, wherein two oblique surface sections (6, 7) are provided, one of the oblique surface sections (6) interacts with the projection (4) of the synchronizer ring (2), upon rotation of the synchronizer ring (2) relative to the synchronizer hub (1) in one direction of rotation, and the other surface section (7) interacts with the projection (4) of the synchronizer ring (2), upon rotation of the synchronizer ring (2) in an opposite direction of rotation.

26. The synchronizer device according to claim 25, wherein the oblique surface sections (6, 7) face one another by way of radially inwardly located ends (14, 15) thereof.

27. The synchronizer device according to claim 25, wherein the projection (4) of the synchronizer ring (2) and the oblique surface sections (6, 7), in a neutral position of the synchronizer ring (2) relative to the synchronizer hub (1), overlap in the circumferential direction.

28. The synchronizer device according to claim 17, wherein at least two oblique surface sections (6, 6′; 7, 7′), which lie one behind another as viewed in the axial direction, are provided on the synchronizer hub (1), on which the projection (4) of the synchronizer ring (2) can rest.

29. The synchronizer device according to claim 17, wherein the synchronizer device (100) is designed for one of single synchronization, double synchronization, and triple synchronization.

30. A manual transmission in combination with a synchronizer device (100) comprising a synchronizer hub (1) and at least one synchronizer ring (2), which are connectable relative to one another in a circumferential direction by an indexing element (3), the indexing element (3) being at least one projection (4) disposed on the synchronizer ring (2) and extending substantially in an axial direction, which engages in at least one recess (5) of the synchronizer hub (1), the recess (5) having at least one oblique surface section (6; 7) on which the projection (4) rests, in a sliding manner, when the synchronizer ring (2) rotates relative to the synchronizer hub (1).
